(19) United States
(12) Patent Application Publication
(10) Pub. No.: US 2012/0020655 A1
(43) Pub. Date: Jan. 26, 2012

(54) LENS MODULE AND TEMPERATURE-COMPENSATING METHOD THEREOF

(75) Inventor: CHAO-HAN PAO, Miao-Li (TW)

(73) Assignee: ABILITY ENTERPRISE CO., LTD., TAIPEI (TW)

(21) Appl. No.: 12/959,314

(22) Filed: Dec. 2, 2010

(30) Foreign Application Priority Data
Jul. 21, 2010 (TW) 099123982

(51) Int. Cl. G03B 17/00; H04N 5/225; G02B 15/14

(52) U.S. Cl. 396/72; 359/676; 348/335; 348/E05.024

(57) ABSTRACT

Embodiments of the present invention disclose a lens module and its temperature-compensating method. The lens module primarily includes several lenses and a compensating lens. The several lenses comprise two plastic lenses and the ratio of the focal length of one plastic lens to the other is predetermined. The temperature-compensating method employs the compensating lens to shift alone an optical axis for compensation of the focal length departure. In one embodiment, the ratio of the two focal lengths is more than or equal to 0.5 and less than or equal to 2.

### CROSS-REFERENCE TO RELATED APPLICATIONS

The entire contents of Taiwan Patent Application No. 099123982, filed on Jul. 21, 2010, from which this application claims priority, are incorporated herein by reference.

### BACKGROUND OF THE INVENTION

1. Field of the Invention

The present invention relates to lens modules and their temperature-compensating method.

2. Description of Related Art

Image-capturing devices, such as digital cameras and digital camcorders, employ lens module (also referred to as zoom lens) and image sensor to collect image beam and turn it into digital signals, for following processing, transmitting, and storage.

Typically, the lens module of the image-capturing devices consists of several lenses. To offer competitive prices, one or more plastic lenses are employed in the lens module; however, the refractive index of the plastic lens will fluctuate as the temperature is varied, resulting in the focal length shifted.

For compensating the focal length departure, the displacements of focus lenses of the lens module are necessarily increased. Larger focus lenses displacement space is thus necessary for the increased displacements, causing that the volume of the lens module is inevitably increased and a compact-size image-capturing device is difficult to design.

Therefore, it would be advantageous to provide a novel lens module or compensating method, especially a compact-size lens module or compensating method, having advantages of easy to produce and low cost.

### SUMMARY OF THE INVENTION

An object of the present invention is to provide a novel lens module or compensating method, especially a compact-size lens module or compensating method, having advantages of easy to produce and low cost.

Accordingly, one embodiment of this invention provides a lens module, in order from an object side to an image-forming side, primarily comprising: a first lens group having negative power and consisting of a first lens and a second lens; a second lens group having positive power and consisting of a third lens, a fourth lens, and a fifth lens; and a third lens group having positive power and consisting of a sixth lens; wherein the second lens, the fifth lens, and the sixth lens are plastic lenses, the focal length of the second lens is f2, the focal length of the fifth lens is f5, and f2 and f5 satisfy the following condition:

$$0.5 \leq \frac{f 2}{\vert f 5 \vert} \leq 2.$$

Accordingly, another embodiment of this invention provides a temperature-compensating method for a lens module, which primarily comprises, from an object side to an image-forming side, a plurality of lenses and a compensating lens, the plurality of lenses at least comprising two plastic lenses, and the ratio of the focal length of one plastic lens to the other being predetermined, and the compensating method comprising: employing the compensating lens to shift alone an optical axis for compensation of the focal length departure according to a operating temperature, when the operating temperature is varied from −10° C. to 50° C., the displacement of the compensating lens is less than or equal to 0.10 mm at the wide-angle end and less than or equal to 0.11 mm at the telephoto end.

### BRIEF DESCRIPTION OF THE DRAWINGS

FIG. 1 shows a lens module according to a preferred embodiment of this invention.

FIG. 2A to FIG. 2C show the detail information of the lens module according to an embodiment of this invention.

FIG. 3A and FIG. 3B respectively show the displacement of the compensating lens for compensating the focal length departure at the wide-angle end and the telephoto end, according to conventional lens module.

FIG. 4A and FIG. 4B respectively show the displacement of the compensating lens for compensating the focal length departure at the wide-angle end and the telephoto end, according to the lens module of this invention.

### DESCRIPTION OF THE PREFERRED EMBODIMENT

Reference will now be made in detail to specific embodiments of the invention. Examples of these embodiments are illustrated in accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well-known components and process operations have not been described in detail in order not to unnecessarily obscure the present invention. While drawings are illustrated in detail, it is appreciated that the quantity of the disclosed components may be greater or less than that disclosed, except where expressly restricting the amount of the components.

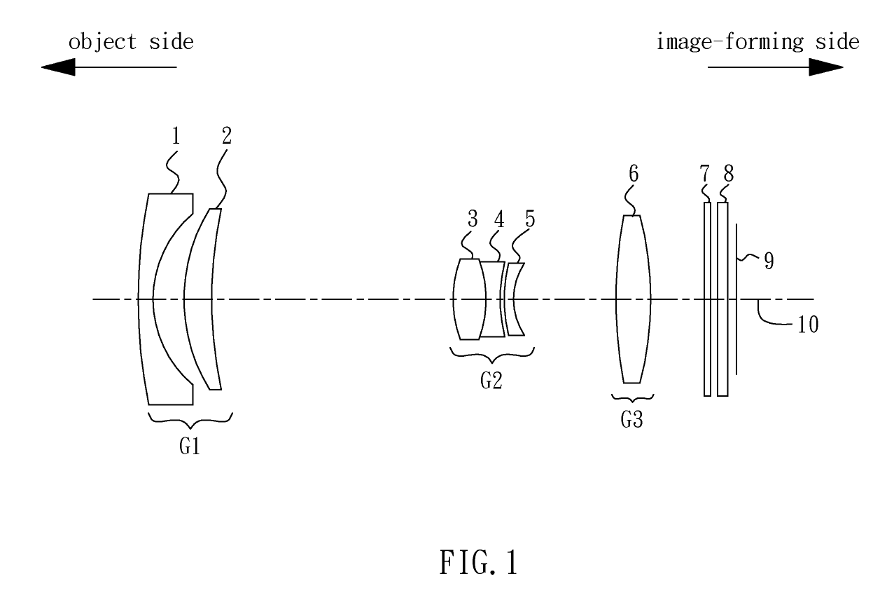

FIG. 1 shows a lens module according to a preferred embodiment of this invention. To highlight features of this invention, the drawing merely shows related components of this embodiment, and other irrelevant or minor components are omitted. The lens module illustrated by this embodiment may be employed in an image-capturing device, such as a digital camera.

In this embodiment, the lens module primarily consists, in order from an object side to an image-forming side and along an optical axis 10, of a first lens group G1, a second lens group G2, and a third lens group G3. The first lens group G1 has negative (refractive) power and consists of a first lens 1 and a second lens 2. The second lens group G2 has positive power and consists of a third lens 3, a fourth lens 4, and a fifth lens 5. The third lens group G3 has positive power and consists of a sixth lens 6. In addition, a flat lens 7 and a flat lens 8 may be arranged between the sixth lens 6 and an image-forming surface 9.

Besides, the second lens 2, the fifth lens 5, and the sixth lens 6 are made of plastic, i.e., plastic lens, wherein the focal length of the second lens 2 is f2, the focal length of the fifth lens 5 is f5, and f2 and f5 satisfy the following condition:

$$0.5 \leq \frac{f 2}{\vert f 5 \vert} \leq 2.$$

In this embodiment, the first lens 1 is a negative convex-concave lens having a convex surface toward to the object side (i.e., concave on the image-forming side); the second lens 2 is a positive convex-concave lens having a convex surface toward to the object side; the third lens 3 is a biconvex lens; the fourth lens 4 is a biconcave lens; the fifth lens 5 is a negative convex-concave lens having a convex surface toward to the object side; and the sixth lens 6 is a biconvex lens. In other embodiments of this invention, the above-mentioned six lenses may have different configurations.

In another embodiment of this invention, the above-mentioned f2 and f5 satisfy the following condition:

$$0.8 \leq \frac{f 2}{\vert f 5 \vert} \leq 1.8 .$$

In another embodiment of this invention, the above-mentioned f2 and f5 satisfy the following condition:

$$1 \leq \frac{f 2}{\vert f 5 \vert} \leq 1.7 .$$

In another embodiment of this invention, the above-mentioned f2 and f5 satisfy the following condition:

$$1.2 \leq \frac{f 2}{\vert f 5 \vert} \leq 1.6 .$$

According to the embodiment of this invention, the second lens 2, the fifth lens 5, and the sixth lens 6 are aspherical lenses, and both faces of each aspherical lens are aspherical surfaces satisfying the following equation:

$$Z = \frac{{CY}^{2}}{1 + \sqrt{1 - ( K + 1 ) {C}^{2} {Y}^{2}}} + {AY}^{4} + {BY}^{6} + {CY}^{8} + {DY}^{10} ,$$

where Z is the coordinate in the optical axis 10 direction, Y is the coordinate in a direction perpendicular to the optical axis 10 in which direction light propagates as positive, R is the radius of curvature, C is reciprocal of R (C=1/R), K is coefficient of quadratic surface, and A, B, C, and D are aspherical coefficients. Coefficients of each aspherical lens are predetermined to determine the focal length and thus satisfy the above-mentioned conditions.

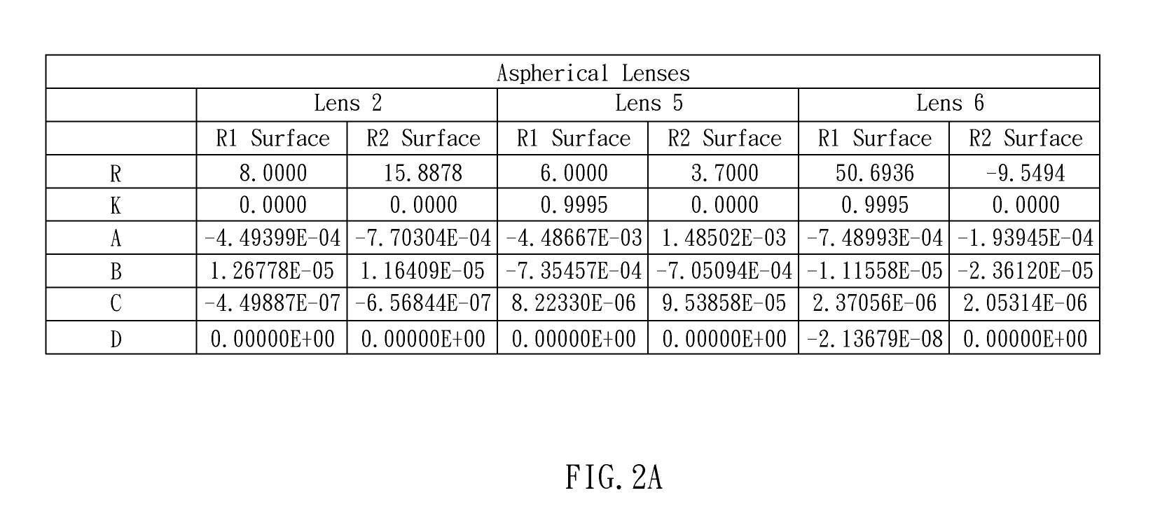

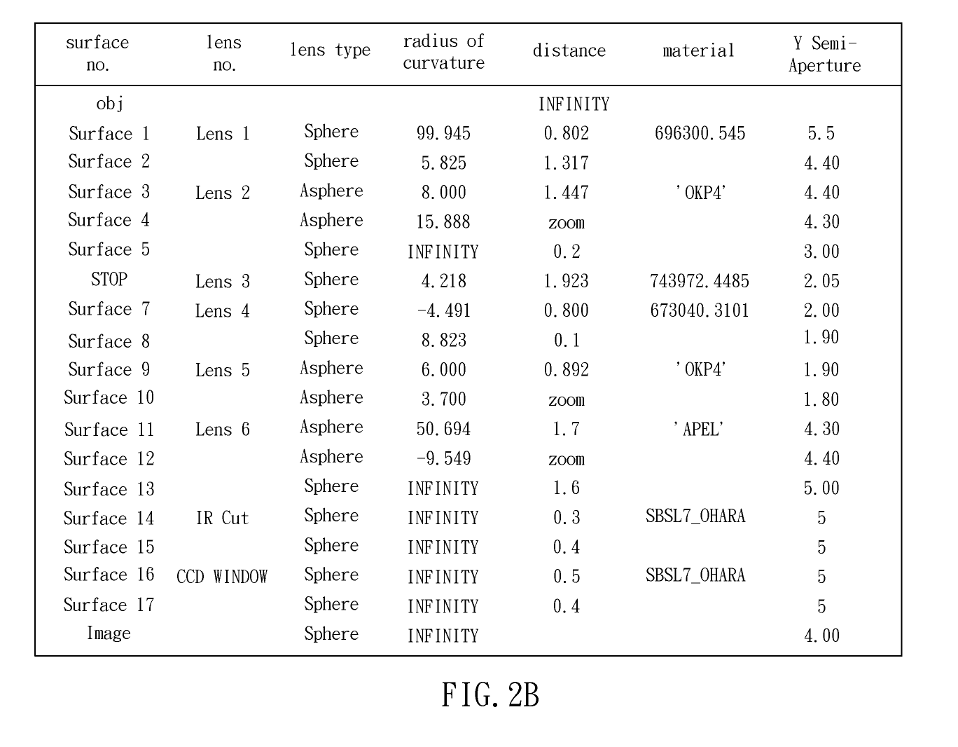

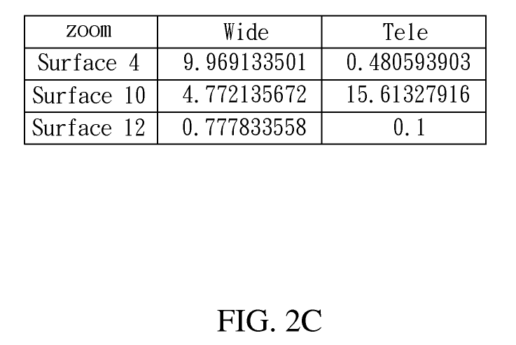

FIG. 2A to FIG. 2C show the detail information of the lens module according to an embodiment of this invention. FIG. 2A show data of three aspherical lenses. Each aspherical lens has two aspherical surfaces in which R1 surface toward to the object side and R2 surface toward to the image-forming side, each aspherical surface has an individual set of coefficients, and thus six sets of coefficients are totally presented. Taking the R1 surface of the second lens 2 as example, its radius of curvature is 8.000, coefficient K is 0.0000, coefficient A is −4.49399E-04, coefficient B is 1.26778E-05, coefficient C is −4.49887E-07, and coefficient D is 0.00000E+00.

FIG. 2B shows the detail information of the lens module shown in FIG. 1 in which the three aspherical lenses of FIG. 2A are applied. The information includes “surface no.,” “lens no.,” “radius of curvature,” “distance,” “material,” and “Y semi-aperture,” where the numbers of surfaces are sequentially numbered from the object side to the image-forming side. For example, “surface 1” denotes the surface of the first lens 1 toward to the object side, “surface 2” denotes the surface of the first lens 2 toward to the image-forming side, “surface 3” denotes the surface of the second lens 2 toward to the object side, and so on. In addition, “distance” indicates the distance between the indicated surface and the next surface, and “zoom” labeled in the “distance” column indicates that the distance between two surfaces depend on the telephoto end (abbr. tele, the long focal point end) or the wide-angle end (abbr. wide, a short focal point end), as shown in FIG. 2C. In addition, the seventh lens, i.e., the flat lens 7, whose surface toward to the image-forming side, i.e., “surface 14,” may have infrared rays cut coating (IR-cut coating), and the eighth lens 8, i.e. the flat lens 8, may be used for protecting the image-forming surface 9.

According to the embodiments of this invention, the plastic lenses or the aspherical lenses may be made of a material selected from the group consisting of polycarbonate, polyester resin (such as OKP4), and cyclic olefin copolymers (such as APEL).

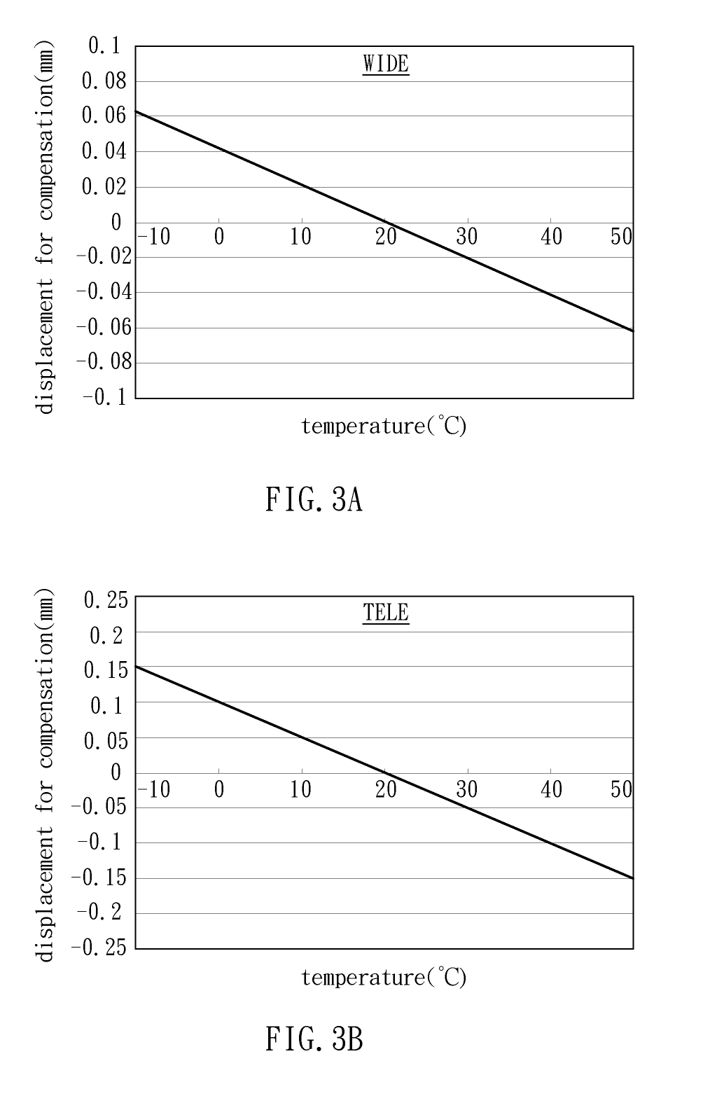

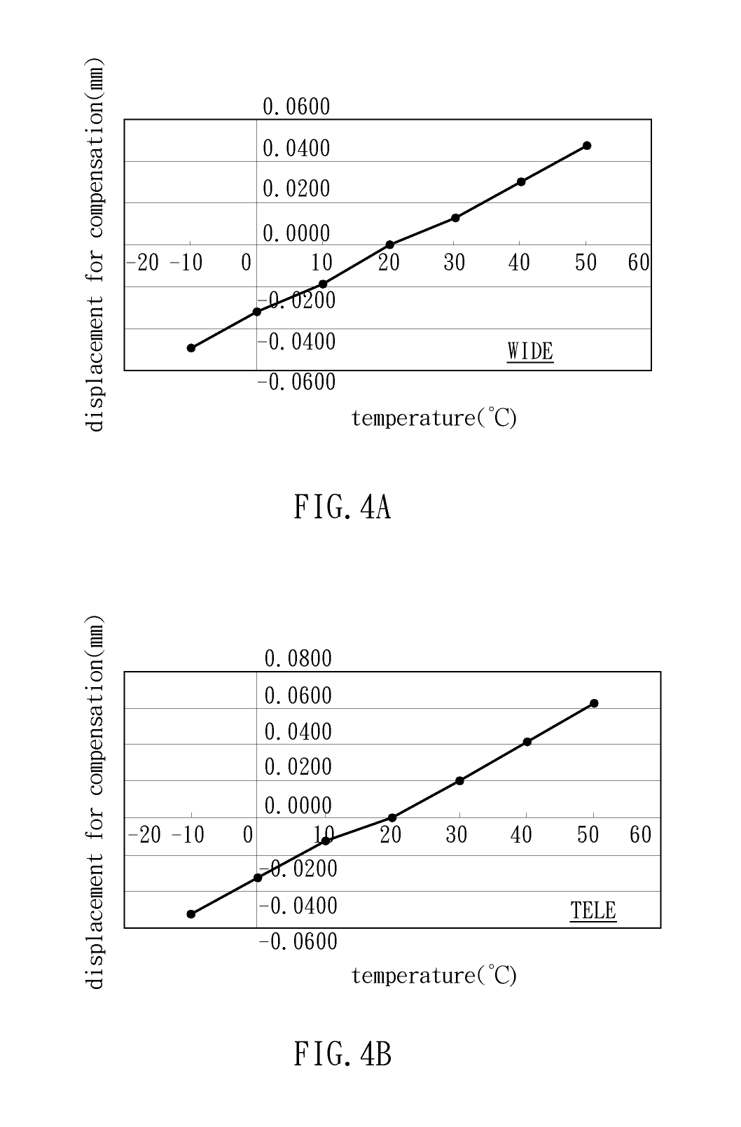

The lens modules of the above-mentioned embodiments employ a lens such as the sixth lens 6 as a compensating lens; it shifts alone the optical axis 10 for compensation of the focal length departure. By using the lens modules of the embodiments of this invention, the displacement of the compensating lens is shorter than that of prior art under the same operating temperature. FIG. 3A and FIG. 3B respectively show the displacement of the compensating lens for compensating the focal length departure at the wide-angle end and the telephoto end, according to conventional lens module. FIG. 4A and FIG. 4B respectively show the displacement of the compensating lens for compensating the focal length departure at the wide-angle end and the telephoto end, according to the lens module of this invention. As shown in FIG. 3A and FIG. 3B, when temperature is varied from −10° C. to 50° C., the displacement of the compensating lens is less than or equal to 0.12 mm at the wide-angle end and less than or equal to 0.3 mm at the telephoto end, according to the conventional lens module; as shown in FIG. 4A and FIG. 4B, when temperature is varied from −10° C. to 50° C., the displacement of the compensating lens is less than or equal to 0.10 mm at the wide-angle end and less than or equal to 0.11 mm at the telephoto end, according to the lens module of this invention. Accordingly, the displacement of the compensating lens is reduced by using the lens modules of this invention; thus the volume of the lens module can be decreased, and the purpose to design a compact-size lens module having advantages of easy to produce and low cost is achieved.

Modification may be made to the lens modules of the embodiments of this invention. For example, the lens module may not be limited to six lenses. Another embodiment of this invention provides a temperature-compensating method for a lens module, which primarily comprises, from the object side to the image-forming side, a plurality of lenses and a compensating lens, wherein the plurality of lenses at least comprise two plastic lenses, and the ratio of the focal length of one plastic lens to the other is predetermined, and the compensating method comprises to employ the compensating lens to shift alone an optical axis for compensation of the focal length departure according to an operating temperature, when the operating temperature is varied from −10° C. to 50° C., the displacement of the compensating lens is less than or equal to 0.10 mm at the wide-angle end and less than or equal to 0.11 mm at the telephoto end.

In addition, if the two focal lengths of two plastic lenses are respectively f1 and f2, then f1 and f2 satisfy the following condition:

$$0.5 \leq \vert \frac{f 1}{f 2} \vert \leq 2 ,$$

and in another embodiment, f1 and f2 satisfy the following condition:

$$0.8 \leq \vert \frac{f 1}{f 2} \vert \leq 1.8 .$$

Although specific embodiments have been illustrated and described, it will be appreciated by those skilled in the art that various modifications may be made without departing from the scope of the present invention, which is intended to be limited solely by the appended claims.

What is claimed is:

1. A lens module, in order from an object side to an image-forming side, primarily comprising:
a first lens group having negative power and consisting of a first lens and a second lens;
a second lens group having positive power and consisting of a third lens, a fourth lens, and a fifth lens; and
a third lens group having positive power and consisting of a sixth lens;
wherein the second lens, the fifth lens, and the sixth lens are plastic lenses, the focal length of the second lens is f2, the focal length of the fifth lens is f5, and f2 and f5 satisfy the following condition:
$$0.5 \leq \frac{f 2}{\vert f 5 \vert} \leq 2.$$

2. The lens module as recited in claim 1, wherein the first lens is a negative convex-concave lens having a convex surface toward to the object side, the second lens is a positive convex-concave lens having a convex surface toward to the object side.

3. The lens module as recited in claim 1, wherein the third lens is a biconvex lens, the fourth lens is a biconcave lens, and the fifth lens is a negative convex-concave lens having a convex surface toward to the object side.

4. The lens module as recited in claim 1, wherein the sixth lens is a biconvex lens.

5. The lens module as recited in claim 1, wherein f2 and f5 satisfy the following condition:
$$0.8 \leq \frac{f 2}{\vert f 5 \vert} \leq 1.8 .$$

6. The lens module as recited in claim 1, wherein f2 and f5 satisfy the following condition:
$$1 \leq \frac{f 2}{\vert f 5 \vert} \leq 1.7 .$$

7. The lens module as recited in claim 1, wherein f2 and f5 satisfy the following condition:
$$1.2 \leq \frac{f 2}{\vert f 5 \vert} \leq 1.6 .$$

8. The lens module as recited in claim 1, wherein the second lens, the fifth lens, and the sixth lens are aspherical lenses, and both faces of each aspherical lens are aspherical surfaces satisfying the following equation:
$$Z = \frac{{CY}^{2}}{1 + \sqrt{1 - ( K + 1 ) {C}^{2} {Y}^{2}}} + {AY}^{4} + {BY}^{6} + {CY}^{8} + {DY}^{10} ,$$
wherein Z is the coordinate in an optical axis direction, Y is the coordinate in a direction perpendicular to the optical axis in which direction light propagates as positive, R is the radius of curvature, C is reciprocal of R (C=1/R), K is coefficient of quadratic surface, A, B, C, and D are aspherical coefficients, and coefficients of each aspherical lens are predetermined to determine the focal length and thus satisfy the above-mentioned condition.

9. The lens module as recited in claim 1, wherein the plastic lenses are made of polycarbonate.

10. The lens module as recited in claim 1, wherein the plastic lenses are made of a polyester resin.

11. The lens module as recited in claim 1, wherein the plastic lenses are made of a cyclic olefin copolymer.

12. The lens module as recited in claim 1, wherein the sixth lens shifts alone an optical axis for compensation of the focal length departure.

13. The lens module as recited in claim 12, wherein the displacement of the sixth lens is less than or equal to 0.10 mm at the wide-angle end and less than or equal to 0.11 mm at the telephoto end, when temperature is varied from −10° C. to 50° C.

14. The lens module as recited in claim 1, wherein the lens module is applied in an image-capturing device.

15. The lens module as recited in claim 14, wherein the image-capturing device comprises a digital camera.

16. A temperature-compensating method for a lens module, which primarily comprises, from an object side to an image-forming side, a plurality of lenses and a compensating lens, the plurality of lenses at least comprising two plastic lenses, and the ratio of the focal length of one plastic lens to the other being predetermined, and the compensating method comprising: employing the compensating lens to shift alone an optical axis for compensation of the focal length departure according to an operating temperature, when the operating temperature is varied from −10° C. to 50° C., the displacement of the compensating lens is less than or equal to 0.10 mm at the wide-angle end and less than or equal to 0.11 mm at the telephoto end.

17. The temperature-compensating method as recited in claim 16, if the two focal lengths of two plastic lenses are respectively f1 and f2, then f1 and f2 satisfy the following condition:
$$0.5 \leq \vert \frac{f 1}{f 2} \vert \leq 2.$$

18. The temperature-compensating method as recited in claim 16, if the two focal lengths of two plastic lenses are respectively f1 and f2, then f1 and f2 satisfy the following condition:
$$0.8 \leq \vert \frac{f 1}{f 2} \vert \leq 1.8 .$$
